(19) United States
(12) Patent Application Publication
(10) Pub. No.: US 2024/0336877 A1
(43) Pub. Date: Oct. 10, 2024

(54) ANTIFOULANT COMPOSITIONS AND METHOD FOR MITIGATING FOULING IN NATURAL GAS PROCESSING EQUIPMENT

(71) Applicant: ECOLAB USA INC., St. Paul, MN (US)

(72) Inventors: Jonathan MASERE, Richmond, TX (US); Andrew CHORNEY, Los Angeles, CA (US); Ashish DHAWAN, Aurora, IL (US); Carter Martin SILVERNAIL, Lakeville, MN (US)

(73) Assignee: ECOLAB USA INC., St. Paul, MN (US)

(21) Appl. No.: 18/627,734

(22) Filed: Apr. 5, 2024

Related U.S. Application Data
(60) Provisional application No. 63/494,945, filed on Apr. 7, 2023.

(51) Int. Cl. C11D 3/20; C10L 3/10; C11D 3/22; C11D 3/37; C11D 3/43

(52) U.S. Cl. CPC C11D 3/2048; C10L 3/107; C11D 3/2068; C11D 3/228; C11D 3/378; C11D 3/43; C11D 2111/20

(57) ABSTRACT

The present disclosure provides compositions and method for controlling fouling in a process for cleaning a hydrocarbon gas. The methods may include adding an effective amount of a composition to a conduit including the hydrocarbon gas. The composition includes, for example, various components, additives, and/or solvents. The compositions and methods may also be used for controlling fouling of equipment used during a process for cleaning and compressing a hydrocarbon gas. The equipment may be selected from, for example, a slug catcher, a scrubber, a suction drum, a compressor, and any combination thereof.

### TECHNICAL FIELD

The present disclosure generally relates to compositions and methods for controlling fouling of the equipment used to process raw natural gas.

### BACKGROUND

To enhance the recovery of hydrocarbon from wells, operators inject compositions comprising, for example, water, brine, carbon dioxide and surfactants. The compositions are used to increase and maintain the efficiency of the recovery of oil and gas. Although the compositions vastly improve the efficiency of the hydrocarbon recovery, the additives in the compositions cause significant problems.

For example, water and carbon dioxide can lead to the formation of hydrates, which block pipes. The mixture of water and carbon dioxide is acidic, which leads to the corrosion of the process equipment. As such, corrosion inhibitors are added to the compositions to minimize the damage to the equipment. Typically, corrosion inhibitors are surfactants. Operators also use surfactants or compounds that produce foam as lifting agents. Foam modifies the composition of the subterranean hydrocarbons, thereby increasing the recovery rates of the same. All the aforementioned additives adversely affect operations in downstream processes.

Natural gas compressor stations are prone to fouling due to the deposition of contaminants that are entrained in recovered gas streams. The contaminants include water, hydrocarbon liquids, dissolved hydrocarbons solids, suspended hydrocarbon particles, sand, metal salts, and/or bioorganic material. These materials may be deposited on the internal surfaces of compressors, particularly the entrained solids and the dissolved material when they precipitate out of solution. Additional foulants include gums from oil-field chemicals used upstream of the natural gas processing plant, especially the compressor unit.

Compressors may be more prone to debilitating fouling than the rest of the units at a gas-processing plant. Compressor fouling leads to reduced operational efficiency, mechanical damage of the equipment, and financial losses due to lost productivity during shutdowns. Additional losses may result from the cost of replacing and repairing of damaged equipment. Apart from compressor fouling, deposits also block blowdown valves of slug catchers and stabilizers.

### BRIEF SUMMARY

The present disclosure provides compositions and methods for controlling fouling. In some embodiments, a method for controlling fouling in a process for cleaning a hydrocarbon gas is disclosed, which comprises adding an effective amount of a composition to a conduit comprising the hydrocarbon gas, wherein the composition comprises about 0.05 wt. % to about 20 wt. % of a surface-active agent, about 4 wt. % to about 95 wt. % of an amphiphilic glycol component, and a solvent.

In some embodiments, the hydrocarbon gas is a C₁ hydrocarbon, a C₂ hydrocarbon, a C₃ hydrocarbon, a C₄ hydrocarbon, or any combination thereof.

In some embodiments, the method is carried out online.

In certain embodiments, the amphiphilic glycol component is selected from the following Formula I:

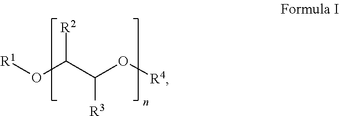

wherein R¹ is a C₁-C₁₈ alkyl group; R² and R³ are each independently selected from the group consisting of hydrogen, methyl, and ethyl, with a proviso that R³ is hydrogen when R² is methyl or ethyl and that R² is hydrogen when R³ is methyl or ethyl; R⁴ is hydrogen or a C₁-C₁₈ alkyl group; and n is an integer selected from 1, 2, 3, 4, or 5.

In some embodiments, the amphiphilic glycol component is selected from the group consisting of ethylene glycol, an ethylene glycol alkyl ether, diethylene glycol, a diethylene glycol alkyl ether, triethylene glycol, a triethylene glycol alkyl ether, propylene glycol, a propylene glycol alkyl ether, dipropylene glycol, a dipropylene glycol alkyl ether, tripropylene glycol, a tripropylene glycol alkyl ether, butylene glycol, a butylene glycol alkyl ether, dibutylene glycol, a dibutylene glycol alkyl ether, tributylene glycol, a tributylene glycol alkyl ether, and any combination thereof. In certain embodiments, the composition comprises from about 10 wt. % to about 50 wt. % of the amphiphilic glycol component.

In some embodiments, the surface-active agent is selected from the group consisting of an anionic surfactant, a nonionic surfactant, a cationic surfactant, a zwitterionic surfactant, and any combination thereof.

In certain embodiments, the effective amount is from about 0.1 ppm to about 30,000 ppm.

In some embodiments, the composition is added upstream or downstream of a primary slug catcher. In some embodiments, the composition is added downstream of a primary slug catcher but upstream of a secondary slug catcher. In certain embodiments, the composition is added downstream of a secondary slug catcher but upstream of a tertiary slug catcher. In some embodiments, the composition is added upstream or downstream of a scrubber.

In some embodiments, the composition further comprises an additive selected from the group consisting of a dispersant, a corrosion inhibitor, an anti-foam agent, a surfactant, an emulsion-stabilizing compound, an imidazoline, an imidazolium compound, agar, carrageenan, gellan, gelatin, guar gum, sodium alginate, xanthan gum, a lignosulfonate, an alkylbenzesulfonate, and any combination thereof. In certain embodiments, the composition comprises from about 1 wt. % to about 20 wt. % of the additive.

In some embodiments, the composition excludes a solid. In some embodiments, a polymerization inhibitor or a retarder is not added to the conduit.

In certain embodiments, the composition consists of or consists essentially of the surface-active agent, the amphiphilic glycol component, the solvent, and optionally the additive. In some embodiments, the method consists of or consists essentially of adding the composition to the conduit.

In some embodiments, the solvent is water.

In certain embodiments, the conduit further comprises a member selected from the group consisting of an entrained hydrocarbon liquid condensate, an entrained aqueous phase, an entrained dissolved organic solid, a dissolved inorganic solid, an insoluble organic solid, an insoluble inorganic solid, and any combination thereof.

The present disclosure also provides a method for removing fouling of equipment used during a process for cleaning and compressing a hydrocarbon gas. The method comprises adding an effective amount of a composition to the equipment comprising the hydrocarbon gas, wherein the composition comprises about 0.05 wt. % to about 20 wt. % of a surface-active agent, about 4 wt. % to about 95 wt. % of an amphiphilic glycol component, and a solvent.

In some embodiments, the equipment is selected from the group consisting of an inlet separator, a slug catcher, a filtration station, a scrubber, a compressor suction drum, a compressor inlet, a compressor piston, and any combination thereof.

In some embodiments, the hydrocarbon gas is a C₁ hydrocarbon, a C₂ hydrocarbon, a C₃ hydrocarbon, a C₄ hydrocarbon, or any combination thereof.

In certain embodiments, the method is carried out online.

In some embodiments, the amphiphilic glycol component is selected from the following Formula I:

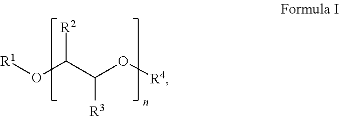

wherein R¹ is a C₁-C₁₈ alkyl group; R² and R³ are each independently selected from the group consisting of hydrogen, methyl, and ethyl, with a proviso that R³ is hydrogen when R² is methyl or ethyl and that R² is hydrogen when R³ is methyl or ethyl; R⁴ is hydrogen or a C₁-C₁₈ alkyl group; and n is an integer selected from 1, 2, 3, 4, or 5.

In some embodiments, the amphiphilic glycol component is selected from the group consisting of ethylene glycol, an ethylene glycol alkyl ether, diethylene glycol, a diethylene glycol alkyl ether, triethylene glycol, a triethylene glycol alkyl ether, propylene glycol, a propylene glycol alkyl ether, dipropylene glycol, a dipropylene glycol alkyl ether, tripropylene glycol, a tripropylene glycol alkyl ether, butylene glycol, a butylene glycol alkyl ether, dibutylene glycol, a dibutylene glycol alkyl ether, tributylene glycol, a tributylene glycol alkyl ether, and any combination thereof.

In certain embodiments, the composition comprises from about 10 wt. % to about 50 wt. % of the amphiphilic glycol component.

In some embodiments, the surface-active agent is selected from the group consisting of an anionic surfactant, a nonionic surfactant, a cationic surfactant, a zwitterionic surfactant, and any combination thereof.

In some embodiments, the effective amount is from about 0.1 ppm to about 30,000 ppm.

In certain embodiments, the composition is added upstream or downstream of a primary slug catcher. In some embodiments, the composition is added downstream of a primary slug catcher but upstream of a secondary slug catcher. In some embodiments, the composition is added downstream of a secondary slug catcher but upstream of a tertiary slug catcher. In certain embodiments, the composition is added upstream or downstream of a scrubber.

In some embodiments, the composition further comprises an additive selected from the group consisting of a dispersant, a corrosion inhibitor, an anti-foam agent, a surfactant, an emulsion-stabilizing compound, an imidazoline, an imidazolium compound, agar, carrageenan, gellan, gelatin, guar gum, sodium alginate, xanthan gum, a lignosulfonate, an alkylbenzesulfonate, and any combination thereof. In some embodiments, the composition comprises from about 1 wt. % to about 20 wt. % of the additive.

In certain embodiments, the composition excludes a solid. In some embodiments, a polymerization inhibitor or a retarder is not added.

In some embodiments, the composition consists of or consists essentially of the surface-active agent, the amphiphilic glycol component, the solvent, and optionally the additive. In certain embodiments, the method consists of or consists essentially of adding the composition to the equipment.

In some embodiments, the solvent is water.

The present disclosure also provides a method for controlling fouling in a process for cleaning a hydrocarbon gas. The method comprises adding a composition to a conduit comprising the hydrocarbon gas, wherein the composition comprises a member selected from the group consisting of a styrene sulfonate polymer, a naphthalene sulfonate formaldehyde condensate polymer, and any combination thereof.

In some embodiments, the styrene sulfonate polymer comprises the following Formula II:

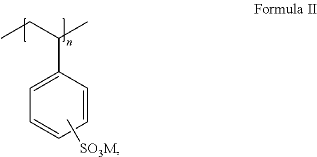

wherein M is hydrogen, an alkali metal, ammonium, or a combination thereof; and n is an integer greater than 10.

In some embodiments, the styrene sulfonate polymer has a weight average molecular weight ranging from about 50,000 Da to about 2,000,000 Da.

In certain embodiments, the naphthalene sulfonate formaldehyde condensate polymer comprises the following Formula III:

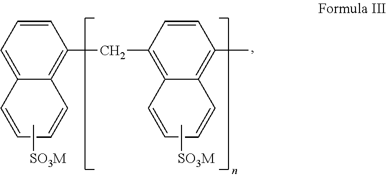

wherein M is hydrogen, an alkali metal, ammonium, or a combination thereof; and n is an integer greater than 10.

In some embodiments, the naphthalene sulfonate formaldehyde condensate polymer has a weight average molecular weight ranging from about 50,000 Da to about 2,000,000 Da.

In some embodiments, the naphthalene sulfonate formaldehyde condensate polymer comprises a sodium salt, a potassium salt, a calcium salt, an ammonium hydroxide salt, or any combination thereof.

In certain embodiments, an amount of the styrene sulfonate polymer, the naphthalene sulfonate formaldehyde condensate polymer, or the combination thereof added to the hydrocarbon gas is from about 0.1 ppm to about 10,000 ppm.

In some embodiments, the composition further comprises a solvent.

In some embodiments, the hydrocarbon gas is a C₁ hydrocarbon, a C₂ hydrocarbon, a C₃ hydrocarbon, a C₄ hydrocarbon, or any combination thereof.

In certain embodiments, the method is carried out online.

In some embodiments, the composition comprises from about 1 wt. % to about 20 wt. % of the styrene sulfonate polymer. In some embodiments, the composition comprises from about 1 wt. % to about 20 wt. % of the naphthalene sulfonate formaldehyde condensate polymer.

In certain embodiments, the composition is added upstream or downstream of a primary slug catcher. In some embodiments, the composition is added downstream of a primary slug catcher but upstream of a secondary slug catcher. In some embodiments, the composition is added downstream of a secondary slug catcher but upstream of a tertiary slug catcher. In certain embodiments, the composition is added upstream or downstream of a scrubber.

In some embodiments, the composition further comprises an additive selected from the group consisting of a dispersant, a corrosion inhibitor, an anti-foam agent, a surfactant, an emulsion-stabilizing compound, an imidazoline, an imidazolium compound, agar, carrageenan, gellan, gelatin, guar gum, sodium alginate, xanthan gum, a lignosulfonate, an alkylbenzesulfonate, and any combination thereof. In some embodiments, the composition comprises from about 1 wt. % to about 20 wt. % of the additive.

In certain embodiments, the composition excludes a solid. In some embodiments, a polymerization inhibitor or a retarder is not added to the conduit.

In some embodiments, the composition consists of or consists essentially of the styrene sulfonate polymer and/or the naphthalene sulfonate formaldehyde condensate polymer, and optionally the solvent and/or the additive. In some embodiments, the method consists of or consists essentially of adding the composition to the conduit.

In certain embodiments, the solvent comprises water, optionally wherein the water is demineralized.

In some embodiments, the conduit further comprises a member selected from the group consisting of an entrained hydrocarbon liquid condensate, an entrained aqueous phase, an entrained dissolved organic solid, a dissolved inorganic solid, an insoluble organic solid, an insoluble inorganic solid, and any combination thereof.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 includes a diagram of a hydrocarbon gas cleaning and compressing plant layout.

### DETAILED DESCRIPTION

Unless otherwise defined, all technical and scientific terms used herein have the same meaning as commonly understood by one of ordinary skill in the art. In case of conflict, the present document, including definitions, will control.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5-or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)-groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions and methods for controlling fouling of the equipment used to clean, compress, and/or process natural gas.

The term “controlling” used herein is intended to encompass actions like abating, reducing, preventing, inhibiting, slowing, etc. For example, controlling fouling may include preventing the deposition of a foulant, reducing an amount of foulant that currently exists in the system, cleaning a foulant from the surface of equipment in the system, etc.

Compositions of the present disclosure may comprise various components. For example, the compositions may comprise a surface-active agent, an amphiphilic glycol component, and water.

In accordance with the present disclosure, the amphiphilic glycol component may be selected from the following Formula I:

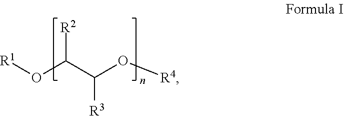

wherein R¹ is a C₁-C₁₈ alkyl group; R² and R³ are each independently selected from the group consisting of hydrogen, methyl, and ethyl, with a proviso that R³ is hydrogen when R² is methyl or ethyl and that R² is hydrogen when R³ is methyl or ethyl; R⁴ is hydrogen or a C₁-C₁₈ alkyl group. In some embodiments, R¹ and R⁴ are independently selected from a C₁ alkyl group, a C₂ alkyl group, a C₃ alkyl group, a C₄ alkyl group, a C₅ alkyl group, a C₆ alkyl group, a C₇ alkyl group, a C₈ alkyl group, a C₉ alkyl group, a C₁₀ alkyl group, a C₁₁ alkyl group, a C₁₂ alkyl group, a C₁₃ alkyl group, a C₁₄ alkyl group, a C₁₅ alkyl group, a C₁₆ alkyl group, a C₁₇ alkyl group, a C₁₈ alkyl group, a C₁-C₁₅ alkyl group, a C₁-C₁₂ alkyl group, a C₁-C₁₀ alkyl group, a C₁-C₇ alkyl group, a C₁-C₅ alkyl group, a C₁-C₄ alkyl group, or a C₁-C₃ alkyl group. The “n” variable is an integer selected from 1, 2, 3, 4, or 5.

In various illustrative, non-limiting embodiments, the amphiphilic glycol component is selected from the group consisting of ethylene glycol, an ethylene glycol alkyl ether, diethylene glycol, a diethylene glycol alkyl ether, triethylene glycol, a triethylene glycol alkyl ether, propylene glycol, a propylene glycol alkyl ether, dipropylene glycol, a dipropylene glycol alkyl ether, tripropylene glycol, a tripropylene glycol alkyl ether, butylene glycol, a butylene glycol alkyl ether, dibutylene glycol, a dibutylene glycol alkyl ether, tributylene glycol, a tributylene glycol alkyl ether, and any combination thereof.

The amount of the amphiphilic glycol component in the composition is not particularly limited. As an illustrative, non-limiting example, the composition may comprise from about 4 wt. % to about 95 wt. % of the amphiphilic glycol component, such as from about 4 wt. % to about 80 wt. %, about 4 wt. % to about 60 wt. %, about 4 wt. % to about 50 wt. %, about 10 wt. % to about 30 wt. %, about 10 wt. % to about 40 wt. %, or about 10 wt % to 50 wt %.

In accordance with the present disclosure, the surface-active agent may comprise, for example, an anionic, nonionic, cationic, and/or a zwitterionic surfactant.

Examples of anionic surfactants include, but are not limited to, carboxylates, such as alkylcarboxylates and polyalkoxycarboxylates, alcohol ethoxylate carboxylates, and nonylphenol ethoxylate carboxylates; sulfonates, such as alkylsulfonates, alkylbenzenesulfonates, alkylarylsulfonates, and sulfonated fatty acid esters; and sulfates, such as sulfated alcohols, sulfated alcohol ethoxylates, sulfated alkylphenols, alkylsulfates, sulfosuccinates, and alkylether sulfates. Specific examples include sodium alkylarylsulfonate, alpha-olefinsulfonate, lignosulfonates, and fatty alcohol sulfates.

Examples of nonionic surfactants include, but are not limited to, those having a polyalkylene oxide polymer as a portion of the surfactant molecule. Such nonionic surfactants include, but are not limited to, chlorine-, benzyl-, methyl-, ethyl-, propyl-, butyl- and other like alkyl-capped polyethylene glycol ethers of fatty alcohols; polyalkylene oxide free nonionics, such as alkyl polyglycosides; sorbitan and sucrose esters and their ethoxylates; alkoxylated amines, such as alkoxylated ethylene diamine; alcohol alkoxylates, such as alcohol ethoxylate propoxylates, alcohol propoxylates, alcohol propoxylate ethoxylate propoxylates, and alcohol ethoxylate butoxylates; nonylphenol ethoxylate, polyoxyethylene glycol ether; carboxylic acid esters, such as glycerol esters, polyoxyethylene esters, ethoxylated and glycol esters of fatty acids; carboxylic amides, such as diethanolamine condensates, monoalkanolamine condensates, and polyoxyethylene fatty acid amides; and polyalkylene oxide block polymers.

An example of a commercially available ethylene oxide/propylene oxide block polymer includes, but is not limited to, PLURONIC®, available from BASF Corporation, Florham Park, N.J. and BEROL® available from AkzoNobel Surface Chemistry, Chicago, Ill. An example of a commercially available silicone surfactant includes, but is not limited to, ABIL® B8852, available from Goldschmidt Chemical Corporation, Hopewell, Va. A suitable surfactant is D500, an ethylene oxide/propylene oxide polymer available from BASF Corporation, Florham Park, N.J.

Examples of cationic surfactants that can be used in the composition include, but are not limited to, amines, such as primary, secondary and tertiary monoamines, optionally with C₁₈ alkyl or alkenyl chains, ethoxylated alkylamines, alkoxylates of ethylenediamine, imidazoles, such as a 1-(2-hydroxyethyl)-2-imidazoline, a 2-alkyl-1-(2-hydroxyethyl)-2-imidazoline, and the like; and quaternary ammonium salts, such as alkylquaternary ammonium chloride surfactants, such as n-alkyl (C₁₂-C₁₈) dimethylbenzyl ammonium chloride, n-tetradecyldimethylbenzylammonium chloride monohydrate, and a naphthylene-substituted quaternary ammonium chloride, such as dimethyl-1-naphthylmethylammonium chloride.

Examples of zwitterionic surfactants that can be used in the composition include, but are not limited to, betaines, imidazolines, and propionates.

In some embodiments, the surface-active agent/surfactant may be any surface-active agent/surfactant disclosed in US Patent Application Publication No. 2019/0316063, the entire contents of which are incorporated into the present application in their entirety.

In some embodiments, the surface-active agent/surfactant is selected from the group consisting of 2-[4-(2,4,4-trimethylpentan-2-yl) phenoxy] ethanol, polyethylene glycol nonylphenyl ether, nonyl phenoxypolyethoxylethanol, ethyl hexanol ethoxylated propoxylated, sodium alkylbenzene sulfonates, sodium stearate, potassium alcohol sulfates, sodium α-sulfo-ω-(dodecyloxy)-poly(oxyethane-1,2-diyl), 4-(5-Dodecyl) benzenesulfonate, phosphatidylcholine, bis (2-ethylhexyl) sulfosuccinate, {[3-(Dodecanoylamino) propyl](dimethyl) ammonio}acetate, and any combination thereof.

In some embodiments, the surface-active agent/surfactant is selected from the group consisting of an ethylene oxide/propylene oxide (EO/PO) copolymer, a capped EO/PO copolymer, an alcohol alkoxylate, a capped alcohol alkoxylate, a block polyoxypropylene-polyoxyethylene polymeric compound, a linear and/or branched primary and/or secondary alkyl sulfonate, an aromatic sulfonate, betaine, sultaine, and any combination thereof.

The amount of the surface-active agent present in the composition is not particularly limited. For example, the composition may comprise from about 0.05 wt. % to about 20 wt. % of a surface-active agent, such as from about 0.1 wt. % to about 20 wt. %, about 0.5 wt. % to about 20 wt. %, about 1 wt. % to about 20 wt. %, about 5 wt. % to about 20 wt. %, about 10 wt. % to about 20 wt. %, or about 15 wt. % to about 20 wt. % of the surface-active agent.

In accordance with certain embodiments of the present disclosure, a composition may comprise a solvent. The solvent may comprise, for example, water, methanol, ethanol, propanol, isopropanol, n-butanol, isobutanol, sec-butanol, tert-butanol, a C₅ to C₁₈ hydrocarbon, or any combination thereof.

In some embodiments, the solvent is water, such as demineralized water.

The amount of solvent present in the composition is not particularly limited. For example, the composition may comprise from about 5 wt. % to about 95 wt. % of the solvent, such as from about 10 wt. % to about 95 wt. %, from about 15 wt. % to about 95 wt. %, from about 20 wt. % to about 95 wt. %, from about 25 wt. % to about 95 wt. %, from about 30 wt. % to about 95 wt. %, from about 35 wt. % to about 95 wt. %, from about 40 wt. % to about 95 wt. %, from about 45 wt. % to about 95 wt. %, from about 50 wt. % to about 95 wt. %, from about 55 wt. % to about 95 wt. %, from about 60 wt. % to about 95 wt. %, from about 65 wt. % to about 95 wt. %, from about 70 wt. % to about 95 wt. %, from about 75 wt. % to about 95 wt. %, from about 80 wt. % to about 95 wt. %, from about 85 wt. % to about 95 wt. %, or from about 90 wt. % to about 95 wt. % of the solvent.

A composition of the present disclosure may optionally comprise an additive. The additive may be selected from, for example, a dispersant, a corrosion inhibitor, an anti-foam agent, a surfactant, an emulsion-stabilizing compound, a chelating agent, a solubility-improving counterion, a wetting agent, an imidazoline, an imidazolium compound, agar, carrageenan, gellan, gelatin, guar gum, sodium alginate, xanthan gum, and any combination thereof.

In some embodiments, the emulsion-stabilizing compound comprises a compound selected from the following Formula II:

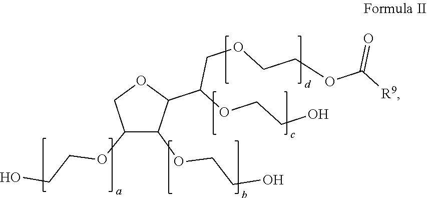

wherein a, b, c, and d are integers independently selected from 1 to 80, a sum of a, b, c and d ranging from about 4 to about 80; and wherein R⁹ is a C₈-C₁₈ alkyl group, a C₈-C₁₈ aryl group, a C₈-C₁₈ alkylaryl group, or a C₈-C₁₈ arylalkyl group.

In some embodiments, “a” is 1, 2, 3, 4, 5, 6, 7, 8, 9, 10, 15, 20, 25, 30, 35, 40, 45, 50, 55, 60, 65, 70, 75, 80, or any sub-range thereof, such as 1-50, 1-40, 1-30, 1-20, 1-10, or 1-5.

In some embodiments, “b” is 1, 2, 3, 4, 5, 6, 7, 8, 9, 10, 15, 20, 25, 30, 35, 40, 45, 50, 55, 60, 65, 70, 75, 80, or any sub-range thereof, such as 1-50, 1-40, 1-30, 1-20, 1-10, or 1-5.

In some embodiments, “c” is 1, 2, 3, 4, 5, 6, 7, 8, 9, 10, 15, 20, 25, 30, 35, 40, 45, 50, 55, 60, 65, 70, 75, 80, or any sub-range thereof, such as 1-50, 1-40, 1-30, 1-20, 1-10, or 1-5.

In some embodiments, “d” is 1, 2, 3, 4, 5, 6, 7, 8, 9, 10, 15, 20, 25, 30, 35, 40, 45, 50, 55, 60, 65, 70, 75, 80, or any sub-range thereof, such as 1-50, 1-40, 1-30, 1-20, 1-10, or 1-5.

The anti-foam compound may comprise one or more compounds selected from, for example, the following Formula I:

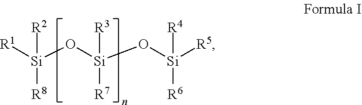

wherein “n” is an integer from 1 to 1000, and R¹, R², R³, R⁴, R⁵, R⁶, R⁷ and R⁸ are independently selected from a C₁-C₁₈ alkyl group, a C₆-C₁₈ aryl group, a C₁-C₁₈ alkylaryl group, a C₇-C₁₈ arylalkyl group, and any combination thereof.

For example, “n” may be selected from 1 to 900, 1 to 800, 1 to 700, 1 to 600, 1 to 500, 1 to 400, 1 to 300, 1 to 200, 1 to 100, 1 to 75, 1 to 50, 1 to 40, 1 to 30, 1 to 20, 1 to 10, 10 to 25, 10 to 35, 10 to 45, 10 to 55, 10 to 75, 10 to 100, 10 to 200, 10 to 300, 10 to 400, 10 to 500, 10 to 600, 10 to 700, 10 to 800, 10 to 900, 50 to 900, 100 to 900, 200 to 900, 300 to 900, 400 to 900, 500 to 900, 600 to 900, 700 to 900 or 800 to 900.

In certain embodiments, R¹, R², R³, R⁴, R⁵, R⁶, R⁷ and R⁸ may be independently selected from a C₁-C₁₈ alkyl group, such as a C₁-C₁₅ alkyl group, a C₁-C₁₂ alkyl group, a C₁-C₁₀ alkyl group, a C₁-C₈ alkyl group, a C₁-C₆ alkyl group, a C₁-C₄ alkyl group, a C₁ or C₂ alkyl group, a C₂-C₁₈ alkyl group, a C₄-C₁₈ alkyl group, a C₆-C₁₈ alkyl group, a C₈-C₁₈ alkyl group, a C₁₀-C₁₈ alkyl group, a C₁₂-C₁₈ alkyl group, a C₁₄-C₁₈ alkyl group, a C₁₆-C₁₈ alkyl group, or a C₁, C₂, C₃, C₄, C₅, C₆, C₇, C₈, C₉, C₁₀, C₁₁, C₁₂, C₁₃, C₁₄, C₁₅, C₁₆, C₁₇, or a C₁₈ alkyl group.

In some embodiments, R¹, R², R³, R⁴, R⁵, R⁶, R⁷ and R⁸ may be independently selected from a C₆-C₁₈ aryl group, such as a C₆-C₁₇ aryl group, a C₆-C₁₆ aryl group, a C₆-C₁₅ aryl group, a C₆-C₁₄ aryl group, a C₆-C₁₃ aryl group, a C₆-C₁₂ aryl group, a C₆-C₁₁ aryl group, a C₆-C₁₀ aryl group, a C₆-C₉ aryl group, a C₆-C₈ aryl group, a C₆-C₇ aryl group, or a C₆, C₇, C₈, C₉, C₁₀, C₁₁, C₁₂, C₁₃, C₁₄, C₁₅, C₁₆, C₁₇, or a C₁₈ aryl group.

In certain embodiments, R¹, R², R³, R⁴, R⁵, R⁶, R⁷ and R⁸ may be independently selected from a C₇-C₁₈ alkylaryl group, such as a C₇-C₁₇ alkylaryl group, a C₇-C₁₆ alkylaryl group, a C₇-C₁₅ alkylaryl group, a C₇-C₁₄ alkylaryl group, a C₇-C₁₃ alkylaryl group, a C₇-C₁₂ alkylaryl group, a C₇-C₁₁ alkylaryl group, a C₇-C₁₀ alkylaryl group, a C₇-C₉ alkylaryl group, a C₇-C₈ alkylaryl group, a C₈-C₁₈ alkylaryl group, a C₉-C₁₈ alkylaryl group, a C₁₀-C₁₈ alkylaryl group, a C₁₁-C₁₈ alkylaryl group, a C₁₂-C₁₈ alkylaryl group, a C₁₃-C₁₈ alkylaryl group, a C₁₄-C₁₈ alkylaryl group, a C₁₅-C₁₈ alkylaryl group, a C₁₆-C₁₈ alkylaryl group, a C₁₇-C₁₈ alkylaryl group, or a C₇, C₈, C₉, C₁₀, C₁₁, C₁₂, C₁₃, C₁₄, C₁₅, C₁₆, C₁₇, or a C₁₈ alkylaryl group.

In some embodiments, R¹, R², R³, R⁴, R⁵, R⁶, R⁷ and R⁸ may be independently selected from a C₇-C₁₈ arylalkyl group, such as a C₇-C₁₇ arylalkyl group, a C₇-C₁₆ arylalkyl group, a C₇-C₁₅ arylalkyl group, a C₇-C₁₄ arylalkyl group, a C₇-C₁₃ arylalkyl group, a C₇-C₁₂ arylalkyl group, a C₇-C₁₁ arylalkyl group, a C₇-C₁₀ arylalkyl group, a C₇-C₉ arylalkyl group, a C₇-C₈ arylalkyl group, or a C₇, C₈, C₉, C₁₀, C₁₁, C₁₂, C₁₃, C₁₄, C₁₅, C₁₆, C₁₇, or a C₁₈ arylalkyl group.

As illustrative, non-limiting examples, R¹, R², R³, R⁴, R⁵, R⁶, R⁷ and R⁸ may be independently selected from a methyl group, an ethyl group, a propyl group, a butyl group, and any combination thereof. As an additional, non-limiting example, each of R¹, R², R³, R⁴, R⁵, R⁶, R⁷ and R⁸ may independently comprise a methyl group or an ethyl group. In some embodiments, all of R¹, R², R³, R⁴, R⁵, R⁶, R⁷ and R⁸ are methyl groups.

In some embodiments, the anti-foam compound is selected from the group consisting of a polydimethylsiloxane, ethylene glycol butyl ether, diethylene glycol methyl ether, diethylene glycol ethyl ether, diethylene glycol butyl ether, triethylene glycol butyl ether, triethylene glycol methyl ether, triethylene glycol ethyl ether, ethylene glycol propyl ether, diethylene glycol propyl ether, triethylene glycol propyl ether, propylene glycol butyl ether, propylene glycol ethyl ether, propylene glycol methyl ether, dipropylene glycol methyl ether, dipropylene glycol ethyl ether, dipropylene glycol butyl ether, tripropylene glycol butyl ether, tripropylene glycol propyl ether, tripropylene glycol methyl ether, butylene glycol methyl ether, butylene glycol ethyl ether, butylene glycol propyl ether, butylene glycol butyl ether, dibutylene glycol butyl ether, tributylene glycol butyl ether, tetraethylene glycol butyl ether, tetrapropylene glycol methyl ether pentaethylene glycol butyl ether, pentapropylene glycol methyl ether ethanol, 2-(2-butoxyethoxy) ethanol (BuCa), ethylene glycol butyl ether (EBGE), propylene glycol (PG), ethylene glycol (EG), hydrophobic silica, silicone oil, and any combination thereof.

In certain embodiments, the anti-foam compound comprises a polydimethylsiloxane.

The corrosion inhibitor disclosed herein may be selected from, for example, an imidazoline, an amidoamine, a quaternary amine, an amide, a monomeric and/or oligomeric fatty acid, an alkoxylated amines, a phosphate esters, and any combination thereof.

In some embodiments, the corrosion inhibitor comprises an imidazoline. The imidazoline may be, for example, imidazoline derived from a diamine, such as ethylene diamine (EDA), diethylene triamine (DETA), triethylene tetraamine (TETA), etc., and a long chain fatty acid, such as TOFA.

The imidazoline may be an imidazoline of Formula (I) and/or a derivative thereof. Representative imidazoline derivatives include, but are not limited to, an imidazolinium compound of Formula (II) or a bis-quaternized compound of Formula (III).

Suitable imidazolines include those of Formula (I):

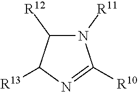

wherein R¹⁰ is a C₁-C₂₀ alkyl or a C₁-C₂₀ alkoxyalkyl group; R¹¹ is hydrogen, C₁-C₆ alkyl, C₁-C₆ hydroxyalkyl, or C₁-C₆ arylalkyl; and R¹² and R¹³ are independently hydrogen or a C₁-C₆ alkyl group. In some embodiments, the imidazoline includes an R¹⁰ which is the alkyl mixture typical in TOFA, and R¹¹, R¹² and R¹³ are each hydrogen.

The corrosion inhibitor component may include an imidazolinium compound of Formula (II):

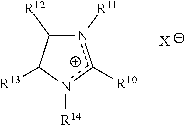

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). In some embodiments, the imidazolinium compound includes 1-benzyl-1-(2-hydroxyethyl)-2-tall-oil-2-imidazolinium chloride.

The corrosion inhibitor may comprise a bis-quaternarized compound having the Formula (III):

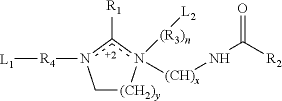

wherein R₁ and R₂ are each independently substituted or unsubstituted branched, chain or ring alkyl or alkenyl having from 1 to about 29 carbon atoms, partially or fully oxygenized, sulfurized, and/or phosphorylized branched, chain, or ring alkyl or alkenyl having from 1 to about 29 carbon atoms, or a combination thereof; R₃ and R₄ are each independently unsubstituted branched, chain or ring alkylene or alkenylene having from 1 to about 29 carbon atoms, partially or fully oxygenized, sulfurized, and/or phosphorylized branched, chain, or ring alkylene or alkenylene having from 1 to about 29 carbon atoms, or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5.

In some embodiments, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene, such as —C₂H₂—; n is 1 and L₂ is —COOH or n is 0 and L₂ is absent or H; x is 2; y is 1; R₃ and R₄ are —C₂H₂—; and L₁ is —COOH.

In certain embodiments, the number of carbon atoms specified for each group of Formula (III) refers to the main chain of carbon atoms and does not include carbon atoms that may be contributed by substituents.

The corrosion inhibitor may comprise a bis-quaternarized imidazoline compound having the Formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. In some embodiments, a bis-quaternarized compound has the Formula (III) wherein R₁ and R₂ are each independently C₁₆-C₁₈ alkyl; R₄ is —C₂H₂; x is 2; y is 1; n is 0; L₁ is —COOH, —SO₃H, or —PO₃H₂ and L₂ is absent or H.

The imidazoline and/or imidazolinium compound may comprise about 0 to about 100 wt. %, about 10 to 60 wt. %, or about 30 to 45 wt. % of the corrosion inhibitor component, based on total weight of the corrosion inhibitor component. For example, the imidazoline and/or imidazolinium compound can constitute about 10 to about 70 wt. %, about 20 to about 60 wt. %, or about 30 to 40 wt. % of the corrosion inhibitor component, based on total weight of the corrosion inhibitor component.

The corrosion inhibitor may be a quaternary ammonium compound of Formula (IV):

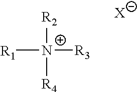

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R^{a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms.

In some embodiments, the quaternary ammonium salt can be a benzyl trialkyl quaternary ammonium salt, a benzyl triethanolamine quaternary ammonium salt, or a benzyl dimethylaminoethanolamine quaternary ammonium salt.

The quaternary ammonium salts may comprise about 0 to about 100 wt. %, about 20 to 80 wt. %, or about 50 to 65 wt. % of the corrosion inhibitor component, based on total weight of the corrosion inhibitor component. For example, the quaternary ammonium salt may comprise about 10 to about 90 wt. %, about 30 to about 70 wt. %, or about 50 to about 60 wt. % of the corrosion inhibitor component, based on total weight of the corrosion inhibitor component.

The corrosion inhibitor may comprise a pyridinium salt such as those represented by Formula (V):

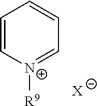

wherein R⁹ is an alkyl group, an aryl group, or an arylalkyl group, wherein said alkyl groups have from 1 to about 18 carbon atoms, and X is a halide, such as chloride, bromide, or iodide. Among these compounds are alkyl pyridinium salts and alkyl pyridinium benzyl quats. Examples of compounds include, but are not limited to, methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride. In some embodiments, the alkyl is a C₁-C₆ hydrocarbyl group. In certain embodiments, the pyridinium compound includes benzyl pyridinium chloride.

The pyridinium salt may constitute about 0 to about 100 wt. %, about 10 to about 60 wt. %, or about 30 to about 40 wt. % of the corrosion inhibitor component, based on total weight of the corrosion inhibitor component.

In some embodiments, the corrosion inhibitor component comprises a phosphate ester. Suitable mono-, di- and tri-alkyl as well as alkylaryl phosphate esters and phosphate esters of mono-, di-, and triethanolamine typically contain between about 1 and about 18 carbon atoms. Examples of mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a more broad distribution of alkyl phosphate esters. Alternatively, the phosphate ester may be made by admixing with an alkyl diester or a mixture of low molecular weight alkyl alcohols and/or diols. The low molecular weight alkyl alcohols and/or diols may include C₆ to C₁₀ alcohols and/or diols. Additional examples include phosphate esters of polyols and their salts containing one or more 2-hydroxyethyl groups, and hydroxylamine phosphate esters obtained by reacting polyphosphoric acid or phosphorus pentoxide with hydroxylamines, such as diethanolamine or triethanolamine.

In some embodiments, the corrosion inhibitor may include a monomeric and/or oligomeric fatty acid. Examples of monomeric and/or oligomeric fatty acids include C₁₄-C₂₂ saturated and unsaturated fatty acids, as well as dimer, trimer and oligomer products obtained by polymerizing one or more of such fatty acids.

The corrosion inhibitor component may comprise an alkoxylated amine. The alkoxylated amine may be an ethoxylated alkyl amine, for example. In some embodiments, the alkoxylated amine comprises ethoxylated tallow amine. The alkoxylated amine may comprise about 0 wt. % to about 100 wt. %, about 10 wt. % to about 60 wt. %, or about 20 wt. % to about 30 wt. % of the corrosion inhibitor component, based on total weight of the corrosion inhibitor component.

A suitable dispersant that may be used in accordance with the present disclosure includes, but is not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra (methylene phosphonate), diethylenetriamine penta (methylene phosphonate) and the triamine- and tetramine-polymethylene phosphonates with 2-4 methylene groups between each N atom, at least 2 of the numbers of methylene groups in each phosphonate being different. Other suitable dispersion agents include lignin or derivatives of lignin such as lignosulfonate and naphthalene sulfonic acid and derivatives.

The amount of the additive present in the composition is not particularly limited. For example, the composition may comprise from about 1 wt. % to about 20 wt. % of the additive, such as from about 1 wt. % to about 15 wt. %, about 1 wt. % to about 10 wt. %, about 1 wt. % to about 5 wt. %, about 5 wt. % to about 20 wt. %, about 10 wt. % to about 20 wt. %, or about 15 wt. % to about 20 wt. % of the additive.

In accordance with certain embodiments of the present disclosure, the composition excludes a solid. In accordance with certain embodiments, the composition excludes a polymerization inhibitor and/or retarder and/or a polymerization inhibitor and/or a retarder is not added to a conduit when carrying out a method of the present disclosure.

In some embodiments, the composition consists of or consists essentially of the surface-active agent, the amphiphilic glycol component, a solvent, and optionally an additive, and/or an additional component.

In accordance with the present disclosure, the additive and/or additional component may be added/injected as part of the composition (with the composition) and/or the additive may be added/injected separately from the composition. In some embodiments, the additive and/or additional component may be added before the composition, with the composition, after the composition, or any combination thereof. In some embodiments, the composition may be added at the same location as the additive and/or additional component or the composition may be added at a different location than the additive and/or additional component.

The present disclosure also provides a composition comprising a member selected from the group consisting of a styrene sulfonate polymer, a naphthalene sulfonate formaldehyde condensate polymer, and any combination thereof. This composition may also include any component, solvent, and/or additive disclosed herein, in the amounts recited herein. For example, the composition may include a solvent in an amount from about 5 wt. % to about 95 wt. %.

The styrene sulfonate polymer may comprise the following Formula II:

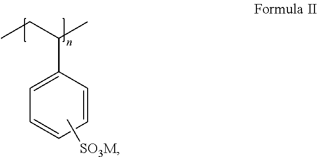

wherein M is hydrogen, an alkali metal, ammonium, or a combination thereof; and n is an integer greater than 10, such as greater than 10 to about 1,000, greater than 10 to about 500, greater than 10 to about 300, greater than 10 to about 100, greater than 10 to about 50, greater than 10 to about 30, about 20 to about 50, about 20 to about 100, about 20 to about 300, about 50 to about 100, about 50 to about 300, or about 50 to about 500.

The weight average molecular weight of the styrene sulfonate polymer is not particularly limited. For example, the weight average molecular weight may be from about 50,000 Da to about 2,000,000 Da, such as from about 50,000 Da to about 1,500,000 Da, about 50,000 Da to about 1,000,000 Da, about 50,000 Da to about 800,000 Da, about 50,000 Da to about 600,000 Da, about 50,000 Da to about 400,000 Da, about 50,000 Da to about 200,000 Da, about 100,000 Da to about 2,000,000 Da, about 100,000 Da to about 1,500,000 Da, or about 100,000 Da to about 1,000,000 Da.

The naphthalene sulfonate formaldehyde condensate polymer may comprise the following Formula III:

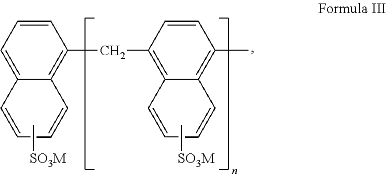

wherein M is hydrogen, an alkali metal, ammonium, or a combination thereof; and n is an integer greater than 10, such as greater than 10 to about 1,000, greater than 10 to about 500, greater than 10 to about 300, greater than 10 to about 100, greater than 10 to about 50, greater than 10 to about 30, about 20 to about 50, about 20 to about 100, about 20 to about 300, about 50 to about 100, about 50 to about 300, or about 50 to about 500.

The weight average molecular weight of the naphthalene sulfonate formaldehyde condensate polymer is not particularly limited. For example, the naphthalene sulfonate formaldehyde condensate polymer may have a weight average molecular weight ranging from about 50,000 Da to about 2,000,000 Da, such as from about 50,000 Da to about 1,500,000 Da, about 50,000 Da to about 1,000,000 Da, about 50,000 Da to about 800,000 Da, about 50,000 Da to about 600,000 Da, about 50,000 Da to about 400,000 Da, about 50,000 Da to about 200,000 Da, about 100,000 Da to about 2,000,000 Da, about 100,000 Da to about 1,500,000 Da, or about 100,000 Da to about 1,000,000 Da.

In accordance with certain embodiments, the naphthalene sulfonate formaldehyde condensate polymer may comprise a sodium salt, such as sodium chloride, a potassium salt, such as potassium chloride, a calcium salt, such as calcium chloride, an ammonium hydroxide salt, or any combination thereof.

The amount of styrene sulfonate polymer in the composition is not particularly limited. For example, the composition may comprise from about 1 wt. % to about 20 wt. % of the styrene sulfonate polymer, such as from about 1 wt. % to about 15 wt. %, about 1 wt. % to about 10 wt. %, about 1 wt. % to about 5 wt. %, about 5 wt. % to about 20 wt. %, about 10 wt. % to about 20 wt. %, or about 15 wt. % to about 20 wt. % of the styrene sulfonate polymer.

The amount of naphthalene sulfonate formaldehyde condensate polymer in the composition is not particularly limited. For example, the composition may comprise from about 1 wt. % to about 20 wt. % of the naphthalene sulfonate formaldehyde condensate polymer, such as from about 1 wt. % to about 15 wt. %, about 1 wt. % to about 10 wt. %, about 1 wt. % to about 5 wt. %, about 5 wt. % to about 20 wt. %, about 10 wt. % to about 20 wt. %, or about 15 wt. % to about 20 wt. % of the naphthalene sulfonate formaldehyde condensate polymer.

In accordance with certain aspects of the present disclosure, a composition disclosed herein may comprise, consist of, or consist essentially of one or more of water, methanol, acetone, an ethylene glycol alkyl ether, a diethylene glycol alkyl ether, a triethylene glycol alkyl ether, a propylene glycol alkyl ether, a dipropylene glycol alkyl ether, a tripropylene glycol alkyl ether, or a butylene glycol alkyl ether. Examples include ethylene glycol butyl ether, diethylene glycol methyl ether, diethylene glycol ethyl ether, diethylene glycol butyl ether, triethylene glycol butyl ether, triethylene glycol methyl ether, triethylene glycol ethyl ether, ethylene glycol propyl ether, diethylene glycol propyl ether, triethylene glycol propyl ether, and any combination thereof. Additional examples include propylene glycol butyl ether, propylene glycol ethyl ether, propylene glycol methyl ether, dipropylene glycol methyl ether, dipropylene glycol ethyl ether, dipropylene glycol butyl ether, tripropylene glycol butyl ether, tripropylene glycol propyl ether, tripropylene glycol methyl ether, butylene glycol methyl ether, butylene glycol ethyl ether, butylene glycol propyl ether, butylene glycol butyl ether, dibutylene glycol butyl ether, tributylene glycol butyl ether, tetraethylene glycol butyl ether, tetrapropylene glycol methyl ether, pentaethylene glycol butyl ether, pentapropylene glycol methyl ether ethanol, 2-(2-butoxyethoxy) ethanol (BuCa), ethylene glycol butyl ether, propylene glycol, ethylene glycol, propylene carbonate, ethylene carbonate, dipropylene glycol, diethylenetriamine, deferoxamine, desferrioxamine, desferal, triazine, tannic acid, malic acid, a monosaccharide sugar acid, ligninosulfonate, polystyrene sulfonate, and any combination thereof.

The compositions and methods disclosed herein are capable of controlling complex foulants, such as those including inorganic salts (e.g., sodium chloride), sand, limestone, water from the gas wells, and/or hydrocarbon from the gas wells.

The foulants that can be controlled by the compositions of the present disclosure may include organic material and/or inorganic material. Organic materials include, for example, hydrocarbon liquids, hydrocarbon gums and insoluble hydrocarbon solids. Inorganic foulants include, for example, halide salts of alkali metals, carbonate salts of alkaline earth metals, as well as sulfide salts of transition metals.

Foulant organic and inorganic particles entrained in the gas or liquid phase have charges on their surfaces. Due to the charges, the particulates can coagulate or agglomerate until they precipitate from the media in which they are suspended. The charges lead to the adhesion of the precipitated and agglomerated solids onto the surfaces of process equipment. It thus becomes imperative to prevent the agglomeration and stickiness of the solids. For this purpose, surface-active agents, such as detergents, are effective in imparting charge neutralization on the particulate surface. Once neutralized, there is a steric barrier of surface-active agents between the particles and the foulant material can be freely washed away by the mobile liquid phase.

The process for the efficient recovery of both gas-phase and liquid-phase hydrocarbons entails the deliberate use of certain chemicals, such as brine and foaming agents. These hydrocarbons, such as natural gas, are typically transferred directly from the field to the processing plant. As a result, sodium chloride in the brine solution is transferred from the gas well to the gas-processing plant. Other additives in drilling and gas-recovery fluids may be similarly entrained with the raw gas and hydrocarbon condensate, such as different types of surfactants.

For example, surfactants are used to prevent the corrosion of assets used in the process of recovering the gas. Filming agents may also be used. As surface-active agents, the filming agents adversely cause stable emulsions and foaming. Surfactants are also deliberately added as foaming agents. Inevitably, foaming anterior to the compressor stage results in the carryover of liquids, dissolved solids and insoluble solids. However, contaminants from the raw gas are not supposed to make it all the way to the compressor stations in a properly functioning gas-cleaning process.

To solve these and other problems, the present disclosure provides methods of using the compositions disclosed herein for controlling fouling in processes for cleaning a hydrocarbon gas. The methods may comprise adding an effective amount of any composition disclosed herein to a conduit comprising the hydrocarbon gas.

In some embodiments, the composition comprises a surface-active agent, an amphiphilic glycol component, and a solvent. In some embodiments, the composition comprises a styrene sulfonate polymer, a naphthalene sulfonate formaldehyde condensate polymer, and any combination thereof.

While a composition of the present disclosure is typically described as being added to a conduit, the composition may also or alternatively be added to a container comprising the hydrocarbon, such as a container on a truck or tanker transporting the hydrocarbon.

The compositions and methods disclosed herein are advantageously effective even if the conduit comprises materials in addition to the hydrocarbon gas, such as an entrained hydrocarbon liquid condensate, an entrained aqueous phase, an entrained dissolved organic solid, a dissolved inorganic solid, an insoluble organic solid, an insoluble inorganic solid, and any combination thereof.

The entrained hydrocarbon liquid condensate may comprise, for example, a C₅ to C₁₈ hydrocarbon, such as a C₅ to C₁₅ hydrocarbon, a C₅ to C₁₂ hydrocarbon, a C₅ to C₉ hydrocarbon, a C₈ to C₁₈ hydrocarbon, a C₁₁ to C₁₈ hydrocarbon, a C₁₅ to C₁₈ hydrocarbon, a C₇ to C₁₅ hydrocarbon, and/or a C₉ to C₁₂ hydrocarbon.

The hydrocarbon gas in the conduit may comprise, for example, a C₁ hydrocarbon, a C₂ hydrocarbon, a C₃ hydrocarbon, a C₄ hydrocarbon, or any combination thereof. In some embodiments, the hydrocarbon gas may comprise methane, ethane, propane, butane, or any combination thereof.

The effective amount of the composition to be added to the conduit is not particularly limited. In some embodiments, the effective amount may be from about 0.1 ppm to about 30,000 ppm. For example, the effective amount may be from about 0.1 ppm to about 5,000 ppm, from about 0.1 ppm to about 2,000 ppm, from about 0.1 ppm to about 1,000 ppm, from about 0.1 ppm to about 750 ppm, from about 0.1 ppm to about 500 ppm, from about 0.1 ppm to about 250 ppm, from about 0.1 ppm to about 100 ppm, from about 0.1 ppm to about 50 ppm, from about 0.1 ppm to about 10 ppm, from about 1 ppm to about 30,000 ppm, from about 10 ppm to about 30,000 ppm, from about 25 ppm to about 10,000 ppm, from about 50 ppm to about 30,000 ppm, from about 100 ppm to about 30,000 ppm, from about 1,000 ppm to about 30,000 ppm, or from about 5,000 ppm to about 30,000 ppm. In some embodiments, the effective amount may be from about 50 ppm to about 2,500 ppm, such as from about 50 ppm to about 2,000 ppm, from about 50 ppm to about 1,500 ppm, from about 50 ppm to about 1,000 ppm, from about 50 ppm to about 500 ppm, from about 70 ppm to about 500 ppm, from about 70 ppm to about 1,500 ppm, or from about 70 ppm to about 2,500 ppm.

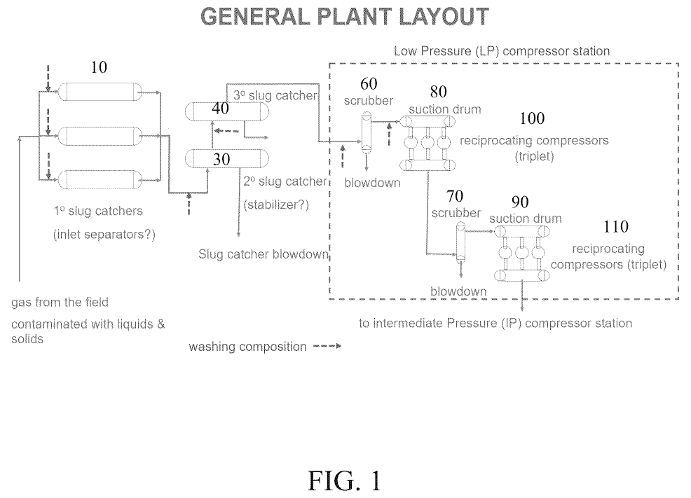

The composition disclosed herein may be added at one or more locations during a process of cleaning and compressing a hydrocarbon gas. For example, FIG. 1 includes dashed arrows showing various locations where a composition of the present disclosure may be added. The compositions may be added to one of these locations, two of these locations, three of these locations, or more than three of these locations during a process of cleaning and compressing a hydrocarbon gas. The compositions may be added continuously or intermittently at any one or more of the locations identified in FIG. 1.

For example, in accordance with some embodiments of the present disclosure, a composition may be added upstream or downstream of a primary slug catcher (10). In some embodiments, the composition is added downstream of a primary slug catcher (10) but upstream of a secondary slug catcher (30). In certain embodiments, the composition may be added upstream of a primary slug catcher (10) but downstream of a subterranean formation (not shown). In various embodiments, the composition is added downstream of a secondary slug catcher (30) but upstream of a tertiary slug catcher (40). In some embodiments, the composition is added upstream or downstream of a scrubber (60,70). In certain embodiments, the composition may be added downstream of a slug catcher (10,30,40) but upstream of a scrubber (60,70). In some embodiments, the composition may be added downstream of a scrubber (60,70) but upstream of a suction drum (80,90) and/or a reciprocating compressor (100,110).

As additional illustrative examples, the composition may be added to one or more of a slug catcher inlet line, a slug catcher discharge line, a scrubber inlet line, and/or a scrubber outlet line leading to the compressor suction drum of the natural gas compressor station.

Any of the methods disclosed herein may consist of or consist essentially of the step of adding the composition to the conduit (at one or more locations depicted in FIG. 1, intermittently, continuously, or any combination thereof).

The present disclosure also provides methods for controlling fouling of equipment used during a process for cleaning and compressing any hydrocarbon gas disclosed herein. The methods may comprise, for example, adding an effective amount of any composition disclosed herein to the equipment comprising the hydrocarbon gas.

The methods disclosed herein are useful for controlling fouling of any piece of equipment that may be used during the cleaning and compressing processes, such as a slug catcher (10, 30, 40), a scrubber (60, 70), a suction drum (80, 90), a reciprocating compressor (100, 110), and any combination thereof. In some embodiments, the composition is added to a conduit upstream of the particular piece or pieces of equipment to be treated.

The effective amount of the composition to be added to the equipment is not particularly limited. In some embodiments, the effective amount may be from about 0.1 ppm to about 30,000 ppm. For example, the effective amount may be from about 0.1 ppm to about 5,000 ppm, from about 0.1 ppm to about 2,000 ppm, from about 0.1 ppm to about 1,000 ppm, from about 0.1 ppm to about 750 ppm, from about 0.1 ppm to about 500 ppm, from about 0.1 ppm to about 250 ppm, from about 0.1 ppm to about 100 ppm, from about 0.1 ppm to about 50 ppm, from about 0.1 ppm to about 10 ppm, from about 1 ppm to about 30,000 ppm, from about 10 ppm to about 30,000 ppm, from about 25 ppm to about 30,000 ppm, from about 50 ppm to about 30,000 ppm, from about 100 ppm to about 30,000 ppm, from about 1,000 ppm to about 30,000 ppm, or from about 5,000 ppm to about 30,000 ppm. In some embodiments, the effective amount is from about 200 ppm to about 2,500 ppm, from about 200 ppm to about 1,000 ppm, from about 500 to about 2,500 ppm, or from about 1,000 ppm to about 2,500 ppm.

In certain embodiments, if the composition comprises, consists of, or consists essentially of a member selected from the group consisting of a styrene sulfonate polymer, a naphthalene sulfonate formaldehyde condensate polymer, and any combination thereof, the amount of the composition to be added to the conduit and/or the equipment may be between about 1 ppm and about 10,000 ppm, such as from about 1 ppm to about 8,000 ppm, about 1 ppm to about 6,000 ppm, about 1 ppm to about 4,000 ppm, about 1 ppm to about 2,000 ppm, about 1 ppm to about 1,000 ppm, about 1 ppm to about 500 ppm, about 10 ppm to about 500 ppm, about 10 ppm to about 1,000 ppm, about 10 ppm to about 3,000 ppm, about 10 ppm to about 5,000 ppm, about 20 ppm to about 200 ppm, about 20 ppm to about 400 ppm, about 20 ppm to about 600 ppm, about 20 ppm to about 800 ppm, or about 20 ppm to about 1,000 ppm.

The equipment and/or conduit (if applicable) may comprise other materials in addition to the hydrocarbon gas, such as an entrained hydrocarbon liquid condensate, an entrained aqueous phase, an entrained dissolved organic solid, a dissolved inorganic solid, an insoluble organic solid, an insoluble inorganic solid, and any combination thereof.

The composition may be added at any location, or any combination of locations disclosed in the present application and/or in FIG. 1. The composition may be added continuously, intermittently, or any combination thereof at the one or more locations.

In some embodiments, the method consists of or consists essentially of adding the composition to the equipment to be treated and/or to a conduit upstream of the equipment to be treated.

The compositions disclosed herein may be added to the conduit and/or to the equipment at operating temperatures, such as temperatures from about −10° C. to about 50° C., such as from about 0° C. to about 45° C., about 5° C. to about 40° C., or about 10° C. to about 35° C. In some embodiments, the composition is added at ambient temperature, which covers a temperature range from about 15° C. to about 30° C.

The methods disclosed herein may advantageously be carried out online, meaning that the methods may be carried out while conducting the gas cleaning and/or compressing processes as opposed to carrying out the methods when the gas cleaning and/or compressing processes are shut down. The cleaning and/or compressing processes do not need to be halted/shut down while carrying out the methods of the present disclosure.

The foregoing may be better understood by reference to the following examples, which are intended for illustrative purposes and are not intended to limit the scope of the disclosure or its application in any way.

### Examples

A scintillation vial was loaded with a sticky foulant being placed slightly below the neck of the vial. Water (or other compositions as described in Table 1) was added to the vial and the vial was capped. This point was designated as time zero. The rate of the removal of the foulant from the inner wall of the vial to the bottom was monitored at regular time intervals. At each interval, pictures were captured. With water as a washing medium, the washing of the foulant appeared to take place in two stages. At the point of contact between the foulant material and water, some water-soluble material dissolved in the medium to yield a yellow-colored solution. This solution was denser than the deionized water. It flowed to the bottom of the vial. Some solids were also observed falling from the surface of vial to the bottom. Within about two hours, the foulant on the wall had been completely washed to the bottom of the vial. The performance of water as a washing medium was used as a performance benchmark for the other washing compositions. As the reference washing medium, water was rated 5 on a scale ranging from 1 to 10. A rating of 1 meant the washing medium was poor or ineffective. By contrast, a rating of 10 meant that the washing composition was very effective, with all of the components in the foulant material simultaneously removed from the surface of the vial and dispersed in the medium as a suspension. Results can be seen in Table 1.

TABLE 1
The effectiveness of composition on the cleaning
time of foulants from fouled surface

| | Rank of |
|---|---|
| Composition | Effectiveness |
| Water | 5 |
| Methanol | 4 |
| Ethylene Glycol | 3 |
| Propylene Glycol | 6 |
| Butyl Glycol | 2 |
| Butyl Carbitol | 2 |
| Water & Propylene Glycol | 5 |
| Water + Butyl Carbitol | 9 |
| Water + Butyl Carbitol + Propylene Glycol | 10 |
| Water + Butyl Carbitol + Propylene Glycol + | 10 |
| Lignosulfonate | |
| Water + Butyl Carbitol + Propylene Glycol + | 10 |
| Lignosulfonate + PEGylated Nonylphenol- | |
| Formaldehyde Resin | |

While investigating various compositions, unexpected synergy was discovered with a composition comprising water and butyl carbitol. Water by itself was rated as a “5”. Butyl carbitol was rated as a “2”. However, as can be seen in Table 1, when these were combined, the resulting composition performed as a “9”.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a compound” is intended to include “at least one compound” or “one or more compounds.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method for controlling fouling in a process for cleaning a hydrocarbon gas, comprising:
adding an effective amount of a composition to a conduit comprising the hydrocarbon gas, wherein the composition comprises about 0.05 wt. % to about 20 wt. % of a surface-active agent, about 4 wt. % to about 95 wt. % of an amphiphilic glycol component, and a solvent.

2. The method of claim 1, wherein the hydrocarbon gas is a C₁ hydrocarbon, a C₂ hydrocarbon, a C₃ hydrocarbon, a C₄ hydrocarbon, or any combination thereof.

3. The method of claim 1, wherein the amphiphilic glycol component is selected from the following Formula I: 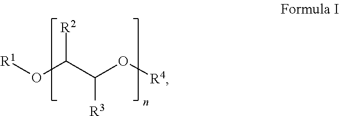
wherein R¹ is a C₁-C₁₈ alkyl group;
R² and R³ are each independently selected from the group consisting of hydrogen, methyl, and ethyl, with a proviso that R³ is hydrogen when R² is methyl or ethyl and that R² is hydrogen when R³ is methyl or ethyl;
R⁴ is hydrogen or a C₁-C₁₈ alkyl group; and
n is an integer selected from 1, 2, 3, 4, or 5.

4. The method of claim 1, wherein the amphiphilic glycol component is selected from the group consisting of ethylene glycol, an ethylene glycol alkyl ether, diethylene glycol, a diethylene glycol alkyl ether, triethylene glycol, a triethylene glycol alkyl ether, propylene glycol, a propylene glycol alkyl ether, dipropylene glycol, a dipropylene glycol alkyl ether, tripropylene glycol, a tripropylene glycol alkyl ether, butylene glycol, a butylene glycol alkyl ether, dibutylene glycol, a dibutylene glycol alkyl ether, tributylene glycol, a tributylene glycol alkyl ether, and any combination thereof.

5. The method of claim 1, wherein the composition comprises from about 10 wt. % to about 50 wt. % of the amphiphilic glycol component.

6. The method of claim 1, wherein the surface-active agent is selected from the group consisting of an anionic surfactant, a nonionic surfactant, a cationic surfactant, a zwitterionic surfactant, and any combination thereof.

7. The method of claim 1, wherein the composition is added upstream or downstream of a primary slug catcher.

8. The method of claim 1, wherein the composition is added downstream of a primary slug catcher but upstream of a secondary slug catcher.

9. The method of claim 1, wherein the composition is added downstream of a secondary slug catcher but upstream of a tertiary slug catcher.

10. The method of claim 1, wherein the composition is added upstream or downstream of a scrubber.

11. The method of claim 1, wherein the composition further comprises an additive selected from the group consisting of a dispersant, a corrosion inhibitor, an anti-foam agent, a surfactant, an emulsion-stabilizing compound, an imidazoline, an imidazolium compound, agar, carrageenan, gellan, gelatin, guar gum, sodium alginate, xanthan gum, a lignosulfonate, an alkylbenzesulfonate, and any combination thereof.

12. The method of claim 1, wherein the composition excludes a solid.

13. The method of claim 1, wherein a polymerization inhibitor or a retarder is not added to the conduit.

14. A method for removing fouling of equipment used during a process for cleaning and compressing a hydrocarbon gas, comprising:
adding an effective amount of a composition to the equipment comprising the hydrocarbon gas, wherein the composition comprises about 0.05 wt. % to about 20 wt. % of a surface-active agent, about 4 wt. % to about 95 wt. % of an amphiphilic glycol component, and a solvent.

15. The method of claim 14, wherein the equipment is selected from the group consisting of an inlet separator, a slug catcher, a filtration station, a scrubber, a compressor suction drum, a compressor inlet, a compressor piston, and any combination thereof.

16. The method of claim 14, wherein the amphiphilic glycol component is selected from the following Formula I: 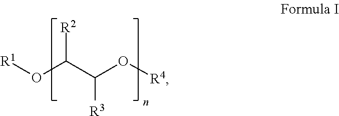
wherein R¹ is a C₁-C₁₈ alkyl group;
R² and R³ are each independently selected from the group consisting of hydrogen, methyl, and ethyl, with a proviso that R³ is hydrogen when R² is methyl or ethyl and that R² is hydrogen when R³ is methyl or ethyl;
R⁴ is hydrogen or a C₁-C₁₈ alkyl group; and
n is an integer selected from 1, 2, 3, 4, or 5.

17. The method of claim 14, wherein the composition consists of or consists essentially of the surface-active agent, the amphiphilic glycol component, the solvent, and optionally the additive.

18. A method for controlling fouling in a process for cleaning a hydrocarbon gas, comprising:
adding a composition to a conduit comprising the hydrocarbon gas, wherein the composition comprises a member selected from the group consisting of a styrene sulfonate polymer, a naphthalene sulfonate formaldehyde condensate polymer, and any combination thereof.

19. The method of claim 18, wherein the styrene sulfonate polymer comprises the following Formula II: 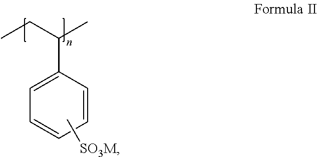
wherein M is hydrogen, an alkali metal, ammonium, or a combination thereof; and
n is an integer greater than 10.

20. The method of claim 18, wherein the naphthalene sulfonate formaldehyde condensate polymer comprises the following Formula III: 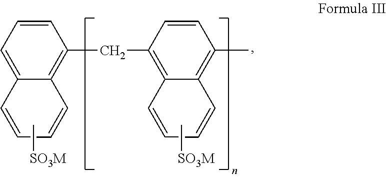
wherein M is hydrogen, an alkali metal, ammonium, or a combination thereof; and
n is an integer greater than 10.
